(19) United States
(12) Patent Application Publication
(10) Pub. No.: US 2026/0135610 A1
(43) Pub. Date: May 14, 2026

(54) OPTIMIZING BANDWIDTH FOR DATA TRANSMISSION IN MULTI-RADIO VEHICLES

(71) Applicant: AeroVironment, Inc., Simi Valley, CA (US)

(72) Inventors: William S. BOWMAN, Melbourne, FL (US); Andrew D. FALENDYSZ, Grant, FL (US); Mark B. MOFFETT, Grant, FL (US); Sean R. WAGONER, West Melbourne, FL (US)

(73) Assignee: AeroVironment, Inc., Simi Valley, CA (US)

(21) Appl. No.: 18/945,425

(22) Filed: Nov. 12, 2024

(51) Int. Cl. H04B 7/185; H04W 4/021

(52) U.S. Cl. CPC H04B 7/18506; H04W 4/021

(57) ABSTRACT

Methods and systems are described herein for optimizing how recorded data frames are sent over multiple radios (e.g., using different frequencies or waveforms) when a recording device (e.g., mounted upon an uncrewed vehicle) is within a transmit zone. A determination may be made that a transmit zone has been entered, and the current network conditions may be evaluated, including available bandwidth and/or latency for each radio. The data frames may be split into smaller portions and assigned with each portion assigned to the most suitable radio based on the frame size and network conditions. This mechanism may ensure efficient use of available bandwidth and reliable data transmission.

### BACKGROUND

Uncrewed systems are becoming increasingly common in various technology fields (e.g., surveillance, environmental monitoring, search and rescue, media production, and others). In many instances, uncrewed systems (e.g., uncrewed aerial vehicles) often record and transmit video to a ground station or control center. Existing technologies for video transmission generally rely on fixed bandwidth allocation and continuous data streaming. However, this may not be optimal in various situations. For example, uncrewed vehicles may be travelling through unfriendly territories where data transmission may be blocked or otherwise unavailable (e.g., to avoid detection). Accordingly, inefficient use of available transmission bandwidth and transmission time, especially in environments (e.g., conflict zones, remote territories, underwater, disaster zones, and/or extreme weather conditions) with variable ad hoc network conditions, may lead to undesired results (e.g., mission failure, vehicle detection, etc.). Thus, efficient use of transmission bandwidth and/or transmission time is important in many applications related to uncrewed and even crewed systems.

### SUMMARY

Therefore, methods and systems are described herein for optimizing a mechanism for bandwidth allocation, thereby optimizing how recorded data is sent when a corresponding recording device (e.g., mounted upon an uncrewed vehicle) is within a transmit zone as determined based on, for example, a mission plan. For example, an uncrewed aerial vehicle equipped with a plurality of radios, with some capable of transmitting data over different frequencies or waveforms, may include a bandwidth optimization system that is used to perform the operations described herein. The bandwidth optimization system may be deployed on a device being moved in an unfriendly territory (e.g., on an uncrewed aerial vehicle, on a terrain-based vehicle, or on a computing device carried by an operator) where the mission plan requires the bandwidth optimization system to optimize transmission of recorded data (e.g., video, sonar, infrared, etc.) as, for example, a vehicle moves through its predetermined route. The route may include zones where transmission of data is unavailable (e.g., areas that lack necessary network infrastructure to support data transmission, areas controlled by unfriendly entities, etc.). As the bandwidth optimization system determines that a transmit zone has been entered, the bandwidth optimization system may evaluate the current network conditions, including available bandwidth and latency for each radio. The bandwidth optimization system may split the data frames into smaller portions and assign each portion to the most suitable radio based on the frame size and network conditions. This mechanism may ensure efficient use of available bandwidth and reliable data transmission. Once the uncrewed aerial vehicle exits the transmit zone, the bandwidth optimization system may terminate the data transmission to comply with mission constraints and avoid detection.

In some embodiments, the bandwidth optimization system may record a data stream (e.g., video, sonar, infrared, etc.) using a recording device (e.g., camera, sonar array, etc.) mounted on an uncrewed vehicle (e.g., aerial, submarine, lunar, humanoid, etc.) or carried by an operator as the host device hosting the bandwidth optimization system is moved according to a mission plan. The mission plan may dictate the uncrewed vehicle's route and objectives, ensuring that the recording device captures relevant areas and/or events. The recorded data stream may serve as the primary data that may be transmitted to a remote device, such as a ground station or control center.

The bandwidth optimization system may detect when the uncrewed vehicle has crossed into a transmit zone. The transmit zone may be a predetermined area specified in the mission plan where data transmission is feasible, enabled, and/or allowed. In some embodiments, detection of the device hosting the bandwidth optimization system within the transmit zone may trigger subsequent operations for data transmission. In some embodiments, the transmit zone may be selected based on factors such as network coverage, signal strength, and/or operation permissions. The selection of the transmit zones may be performed beforehand or on the fly. By detecting the entry into the transmit zone, the bandwidth optimization system may ensure that data transmission occurs only in areas that are optimal (e.g., enabled) and/or secure.

Based on detecting that the uncrewed vehicle has entered the transmit zone, the bandwidth optimization system may determine the corresponding bandwidth and latency values for each radio on board (e.g., on board the uncrewed aerial vehicle). The uncrewed vehicle may be equipped with a plurality of radios (e.g., Wi-Fi, cellular, satellite, etc.) capable of transmitting data over different frequencies or waveforms. This process may ensure that the bandwidth optimization system is enabled to detect the current network conditions and is enabled to optimize data transmission accordingly.

The bandwidth optimization system may split the data frames into smaller portions based on a size of the frames. For example, the frames of a data stream may be divided into multiple groupings or buckets, with each grouping or bucket assigned to a specific radio. For example, one grouping or bucket may be the largest frames, while another grouping or bucket may be frames of a smaller size and so on. That is, the bandwidth optimization system's frame allocation to the plurality of radios may be determined by determining the size of frames along with the corresponding bandwidth and latency values of the radios. This process may ensure that the data is efficiently distributed across the plurality of radios, optimizing the use of available bandwidth and minimizing transmission delays. By splitting the data frames in this way, the bandwidth optimization system may transmit the data more reliably and quickly.

Based on the splitting of the data frames, the bandwidth optimization system may transmit the portions of the data stream over the plurality of radios. For example, each radio may transmit assigned portions of the data to a remote device. This mechanism may enhance the reliability and speed of data transmission, ensuring that the data reaches the ground station or control center without significant delays or data loss. The use of the plurality of radios may enable the bandwidth optimization system to leverage different network paths and frequencies, further improving the efficiency and robustness of the data transmission process.

The bandwidth optimization system may then terminate transmission (e.g., when a non-transmit zone is reached). In particular, the bandwidth optimization system may terminate the data transmission when the bandwidth optimization system determines that the uncrewed vehicle has left the transmit zone. By stopping the transmission when the uncrewed vehicle exits the transmit zone, the bandwidth optimization system may reduce the risk of detection in unfriendly areas.

In some embodiments, the bandwidth optimization system may determine that a portion of the data stream was not transmitted from the uncrewed vehicle when the uncrewed vehicle left the transmit zone (e.g., an uncrewed aerial vehicle flies outside the transmit zone). Based on this determination, the bandwidth optimization system may utilize a machine learning model to determine whether that portion of the data stream includes one or more objects of interest. Based on determining that the portion of the data stream includes the identified objects of interest, the bandwidth optimization system may save the portion that includes the relevant identified objects for transmission when the uncrewed vehicle reaches a different transmit zone. Conversely, if that portion does not include the relevant identified objects, the bandwidth optimization system may delete this portion of the data stream.

Therefore, the described mechanism may ensure that relevant data is preserved and transmitted at the next transmit zone, while nonessential data (e.g., video stream of rural environment not containing unfriendly territories) may be discarded to optimize storage and transmission resources. In some embodiments, the bandwidth optimization system may delete the unsent data when it is determined that a portion of the data stream was not transmitted from the uncrewed vehicle upon exiting the transmit zone. This ensures that any non-transmitted data cannot be accessed by undesired parties.

In some embodiments, the bandwidth optimization system may periodically determine the corresponding bandwidth and/or latency values for each radio of the plurality of radios as the uncrewed vehicle moves through the transmit zone or the device hosting the bandwidth optimization system is moved through the transmit zone. The bandwidth optimization system may also periodically determine the velocity associated with the uncrewed vehicle. Based on the velocity, the bandwidth optimization system may determine an appropriate time interval for determining the corresponding bandwidth and latency values. For example, the faster the uncrewed vehicle moves, the more often the bandwidth optimization system may determine the bandwidth and/or latency values. Additionally, the bandwidth optimization system may determine one or more metrics, such as the signal-to-noise ratio and/or error rate, according to the determined time interval. The bandwidth optimization system's periodic assessment may ensure that the bandwidth optimization system continuously adapts to changing network conditions and optimizes data transmission parameters in real time.

The described methods and systems for optimizing bandwidth may provide a solution for efficient and reliable data transmission in challenging environments. By dynamically evaluating network conditions and strategically distributing data across multiple radios, the bandwidth optimization system may ensure optimal use of available resources within the scope of a mission plan. The bandwidth optimization system may maintain the security and efficiency of the uncrewed vehicle's mission with the possibility of enhancing the speed and reliability of data transmission. The potential to terminate data transmission upon exiting the transmit zone further underscores the bandwidth optimization system's adaptability and effectiveness in meeting mission constraints and avoiding detection in unfriendly territories.

Various other aspects, features, and advantages of the system will be apparent through the detailed description and the drawings attached hereto. It is also to be understood that both the foregoing general description and the following detailed description are examples and not restrictive of the scope of the disclosure. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification, “a portion” refers to a part of, or the entirety of (i.e., the entire portion), a given item (e.g., data) unless the context clearly dictates otherwise.

### BRIEF DESCRIPTION OF THE DRAWINGS

FIG. 1 shows an illustrative system for optimizing transmission of data while in a transmit zone, in accordance with one or more embodiments of this disclosure.

FIG. 2 illustrates an excerpt of a data structure that may store radio throughput and frames assigned to each radio, in accordance with one or more embodiments of this disclosure.

FIG. 3 illustrates an exemplary machine learning model, in accordance with one or more embodiments of this disclosure.

FIG. 4 illustrates a data structure storing different time intervals for different radios, in accordance with one or more embodiments of this disclosure.

FIG. 5 illustrates a computing device, in accordance with one or more embodiments of this disclosure.

FIG. 6 is a flowchart of optimizing transmission of data while in a transmit zone, in accordance with one or more embodiments of this disclosure.

### DETAILED DESCRIPTION

In the following description, for the purposes of explanation, numerous specific details are set forth in order to provide a thorough understanding of the disclosed embodiments. It will be appreciated, however, by those having skill in the art, that the embodiments may be practiced without these specific details or with an equivalent arrangement. In other cases, well-known models and devices are shown in block diagram form in order to avoid unnecessarily obscuring the disclosed embodiments. It should also be noted that the methods and systems disclosed herein are also suitable for applications unrelated to source code programming.

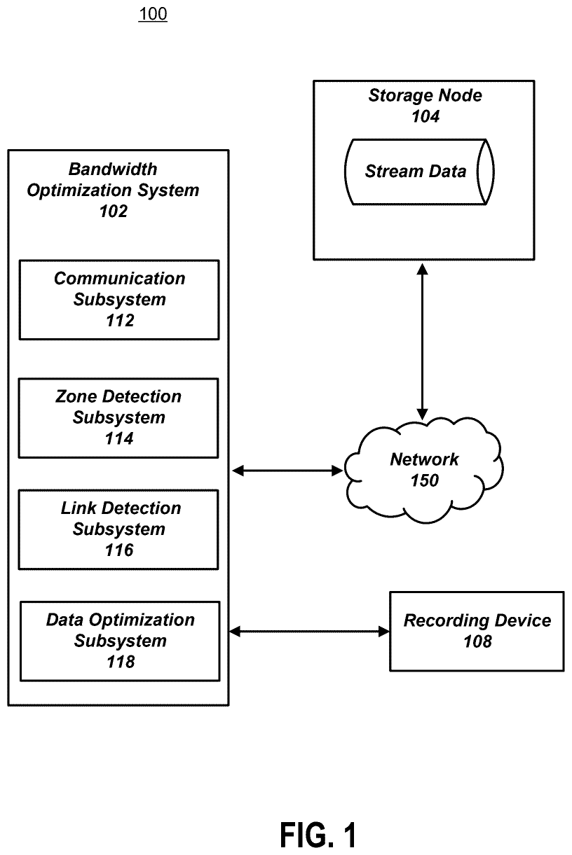

FIG. 1 is an example of environment 100 for optimizing transmission of data when network properties change due to movement. Environment 100 includes bandwidth optimization system 102, storage node 104, and a recording device 108. Bandwidth optimization system 102 may execute instructions for optimizing transmission of data. Bandwidth optimization system 102 may include software, hardware, or a combination of the two. In some embodiments, storage node 104 may reside within a command-and-control center where frames are being sent.

Storage node 104 may store various data. For example, storage node 104 may store image data (e.g., video data) being received by bandwidth optimization system 102. In some embodiments, storage node 104 may also be used to train machine learning models and/or adjust parameters (e.g., hyperparameters) associated with those machine learning models. Storage node 104 may include software, hardware, or a combination of the two. For example, storage node 104 may be a physical server or a virtual server that is running on a physical computer system. In some embodiments, storage node 104 may reside in a datacenter to be used by commanding officers for situational awareness. Network 150 may be a local area network, a wide area network (e.g., the Internet), or a combination of the two. Recording device 108 may be a device attached to a vehicle (e.g., an uncrewed vehicle) or may be a device that is carried by an operator. Recording device 108 may be a video camera, an infrared camera, a microphone, a thermal imaging device, and/or another suitable device.

Bandwidth optimization system 102 may be communicating with a command-and-control center. For example, bandwidth optimization system 102 may be sending image data being captured by a camera mounted onto a vehicle. The vehicle may be wirelessly communicating over a network (e.g., network 150) and may be transmitting image data to storage node 104 using communication subsystem 112. Communication subsystem 112 may include software components, hardware components, or a combination of both. For example, communication subsystem 112 may include a network card (e.g., a wired/wireless network card/processor) that is coupled with software to drive the card/processor. The network card may be built into a vehicle or another suitable computing device.

In some embodiments, bandwidth optimization system 102 may record data using a recording device (e.g., recording device 108). In particular, bandwidth optimization system 102 may record, using a recording device, a data stream as the recording device is moved. In some embodiments, the recording device may be moved according to a mission plan. For example, the mission plan may be a file or a data structure that is loaded onto a computing device on board a vehicle (e.g., an uncrewed vehicle). The recording device may be a video camera, infrared camera, sonar, LIDAR, and/or any other suitable device mounted on an uncrewed vehicle (e.g., mounted onto an aerial vehicle, a submarine, a ground vehicle) and/or carried by an operator. Bandwidth optimization system 102 may have a pre-programmed mission plan that dictates the route for the uncrewed vehicle and/or operator. Bandwidth optimization system 102 may record the data in a particular format (e.g., as a video stream of video frames). For example, the video frames may follow a particular video encoding protocol that is supported by bandwidth optimization system 102. The recorded data stream may serve as the primary data that may be transmitted to storage node 104 using communication subsystem 112.

In some embodiments, bandwidth optimization system 102 may detect that the device hosting the bandwidth optimization system has entered a transmit zone. In particular, zone detection subsystem 114 may detect that the recording device (e.g., recording device 108) has been moved into a transmit zone. In some embodiments, the transmit zone may be a predetermined zone indicated for data transmission in the mission plan. For example, mission planners may have detailed maps of unfriendly locations and the computing device on the vehicle may receive those maps as an input indicating the unfriendly locations.

In some embodiments, the transmit zone may be detected on the fly by zone detection subsystem 114. For example, zone detection subsystem 114 may use a map of coordinates to determine friendly and unfriendly territories and may identify transmit zones within friendly territories marked on a map. Furthermore, zone detection subsystem 114 may use the presence of various signals to identify a transmit zone. For example, if zone detection subsystem 114 identifies jamming signals, radar signals, or other signals indicative of enemy activity (e.g., signal identifiers stored within a database indicating that transmission should not be allowed), zone detection subsystem 114 may identify a particular zone as a non-transmit zone and may disable transmission. However, where those signals are not present, zone detection subsystem 114 may identify a zone as a transmit zone. In some embodiments, the device hosting bandwidth optimization system 102 may be carried by an operator, while in some embodiments, the device hosting bandwidth optimization system 102 may be attached to or built into a vehicle (e.g., an uncrewed aerial vehicle). Thus, the transmit zone maps may be of different granularity (e.g., based on a maximum velocity that may be achieved by the device hosting the bandwidth optimization system) for an aerial vehicle, for a ground vehicle, and for an operator.

Zone detection subsystem 114 may include software components, hardware components, or a combination of both. For example, zone detection subsystem 114 may use one or more processors on board an uncrewed vehicle to execute various software instructions. In some embodiments, zone detection subsystem 114 may determine the transmit zone using GPS coordinates, radio frequency identification, geofencing, or other location-based services integrated into bandwidth optimization system 102. Upon entering the transmit zone, zone detection subsystem 114 may trigger subsequent operations for data transmission.

In some embodiments, zone detection subsystem 114 may, based on detecting that the device hosting bandwidth optimization system 102 has been moved into the transmit zone, generate an indication to link detection subsystem 116 for performing bandwidth and/or latency detection. Link detection subsystem 116 may include software components, hardware components, or a combination of both. For example, link detection subsystem 116 may use one or more processors on board an uncrewed vehicle to execute various software instructions. In particular, link detection subsystem 116 may periodically determine for each radio of a plurality of radios, linked with the recording device as the recording device is moved through the transmit zone, a corresponding bandwidth value and/or a corresponding latency value for transmitting data to a remote device.

In some embodiments, link detection subsystem may continuously monitor network conditions (e.g., of network 150) using software algorithms that may assess the available bandwidth and/or latency for each radio. That is, in some embodiments, link detection subsystem 116 may periodically (e.g., at a particular time interval) determine a bandwidth (e.g., a number of megabits/megabytes) available for sending data without taking latency into account. However, in some embodiments, link detection subsystem 116 may determine both bandwidth and latency. Link detection subsystem 116 may use metrics such as signal-to-noise ratio, error rate, and current network traffic to determine available bandwidth and/or latency for each radio. This periodic assessment may ensure that the bandwidth optimization system 102 adapts to changing network conditions in real time, optimizing data transmission parameters.

In some embodiments, link detection subsystem 116 may be hosted on a device that is mounted onto a vehicle that has been determined to cross into a transmit zone. Thus, based on detecting that the vehicle has crossed into the transmit zone, link detection subsystem 116 may periodically determine, for each radio of a plurality of radios on board the vehicle as the vehicle moves through the transmit zone, a corresponding bandwidth for transmitting data to a remote device. For example, bandwidth optimization system 102 may be receiving encoded video from a camera on board the vehicle. The video may include full frames (e.g., known as I-frames) and partial frames, such as pixel differential from a full frame (e.g., known as P-frames or B-frames). The I-frames may be large in size in comparison to P-frames or B-frames because they contain a large number of pixels as compared to the other types of frames. Accordingly, those frames may need to be sent over a radio or radios having larger bandwidth values and/or lower latency values.

As discussed above, link detection subsystem 116 may perform bandwidth and/or latency detection periodically while the device hosting the bandwidth optimization system is moving through the transmit zone. For example, link detection subsystem 116 may perform bandwidth and/or latency detection at a particular interval (e.g., every minute, every ten minutes, etc.). In some embodiments, link detection subsystem 116 may vary the interval based on the velocity of movement of a device hosting the link detection system. For example, link detection subsystem 116 may periodically determine, for each radio of the plurality of radios, the corresponding bandwidth value and/or the corresponding latency value as an uncrewed aerial vehicle moves through the transmit zone.

To perform this determination, link detection subsystem 116 may periodically determine a velocity associated with the uncrewed aerial vehicle. For example, the device hosting link detection subsystem 116 may be receiving velocity data (e.g., speed and/or direction) from a vehicle that link detection subsystem 116 is mounted on. In some embodiments, link detection subsystem 116 may be equipped with a device that is able to measure speed and/or acceleration of link detection subsystem 116. Link detection subsystem 116 may use other mechanisms to periodically determine the velocity associated with the uncrewed aerial vehicle. It should be noted that this mechanism may be deployed in other scenarios. For example, an operator may be carrying a device hosting link detection subsystem 116. Alternatively, link detection subsystem 116 may be mounted onto a vehicle (e.g., crewed or uncrewed). The vehicle may be aerial, land, or marine.

Based on the velocity, link detection subsystem 116 may determine a time interval for determining the corresponding bandwidth value and/or the corresponding latency value. For example, as the speed of the vehicle changes, it may be important to increase or decrease the number of times or an interval of time for performing bandwidth and/or latency detection. In some embodiments, as the speed of the vehicle increases, link detection subsystem 116 may perform more detections or generate a smaller interval for performing detections. However, as the speed of the vehicle decreases, link detection subsystem 116 may perform fewer detections or generate a larger interval for performing detections.

In some embodiments, link detection subsystem 116 may use signal-to-noise ratio and/or error rates when determining bandwidth and/or latency values. Thus, link detection subsystem 116 may determine one or more of a signal-to-noise ratio or an error rate according to the time interval. Link detection subsystem 116 may make those determinations for each radio of the plurality of radios.

In some embodiments, when link detection subsystem 116 determines the bandwidth and/or latency for all the available radios, link detection subsystem 116 may generate a notification for data optimization subsystem 118 to start frame splitting/frame assignment operations. Data optimization subsystem 118 may include software components, hardware components, or a combination of both. Once data optimization subsystem 118 receives the notification, data optimization subsystem 118 may start executing actions for splitting frames.

In some embodiments, data optimization subsystem 118 may split, based on frame size, a plurality of data frames within the data stream into a plurality of portions to be transmitted by each radio of the plurality of radios. Each data frame of the plurality of data frames may be matched to a radio of the plurality of radios based on a corresponding frame size. For example, data optimization subsystem 118 may identify one or more radios with the largest bandwidth and/or lowest latency and use those radios to transmit the largest data frames. In some embodiments, data optimization subsystem 118 may have access to transmit data over three different radios. A first radio may have 7 megabits per second in bandwidth, a second radio may have 3 megabits per second in bandwidth, and a third radio may have 1 megabit per second in bandwidth. Thus, data optimization subsystem 118 may split the frames into three groups (e.g., based on size). The first group of frames may be the largest frames, with the second group being medium-size frames and the third group being smaller frames. Data optimization subsystem 118 may then send the frames to the three radios based on assignment.

In some embodiments, the data frames may be part of a video stream. Thus, the video stream may include large frames (e.g., I-frames) and smaller frames (e.g., P-frames and/or B-frames). Thus, data optimization subsystem 118 may allocate radios according to frame sizes with the largest bandwidth radio or radios assigned to, for example, I-frames and the other two radios assigned to P-frames and B-frames. In some embodiments, the frames may be frames received from various types of recording devices. For example, frames may be infrared frames, sound navigation and ranging (SONAR) frames, or cloud points of Light Detection and Ranging (LIDAR) devices. Other recording devices or frames may be used with the disclosed embodiments.

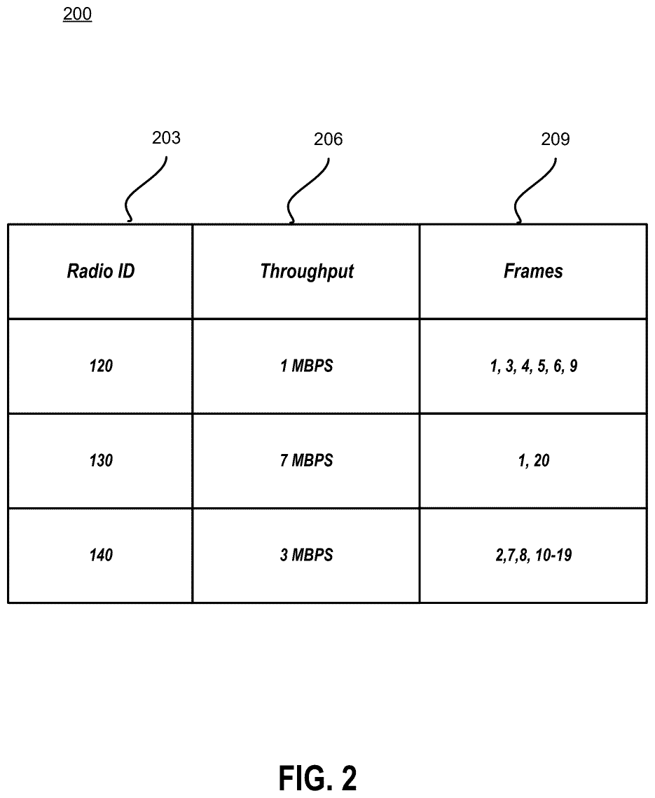

FIG. 2 illustrates an excerpt of a data structure 200 that may store radio throughput and frames assigned to each radio. Fields 203 may store radio identifiers for each radio, for example, on board an uncrewed vehicle. Fields 206 may store the throughput of each radio. In some embodiments, fields 206 may store the bandwidth of each radio (e.g., a number of megabytes or megabits per second). In another example, fields 206 may store a latency instead of or in addition to the bandwidth numbers. Fields 209 may store frames or frame identifiers that were assigned to each corresponding radio.

Data optimization subsystem 118 may use a machine learning model to determine the optimal way to split and allocate frames between different radios based on the bandwidth and/or latency associated with each radio. This may ensure efficient use of available bandwidth and may minimize transmission delays. This mechanism may enhance the reliability and speed of data transmission by leveraging multiple network paths and frequencies. For example, the machine learning model may be trained, for example, using labelled data. The machine learning model may take, as input, a plurality of bandwidth or throughput values (e.g., for each radio) and a plurality of frame identifiers with frame sizes. Based on that information, the machine learning model may output three groups of frames for each radio.

In some embodiments, the machine learning model may be trained based on optimized loads for different numbers of radios and different throughput/bandwidth values. In some embodiments, in addition to or instead of the bandwidth values, the machine learning model may use latency values to output groupings of frames for the radios. Thus, a training routine of the machine learning model may access a dataset that includes training data for training the machine learning model. The training data may include various bandwidth and/or latency values and various optimization outcomes for different numbers of radios. The training routine of the machine learning model may ingest the training data and train the machine learning model based on the training data.

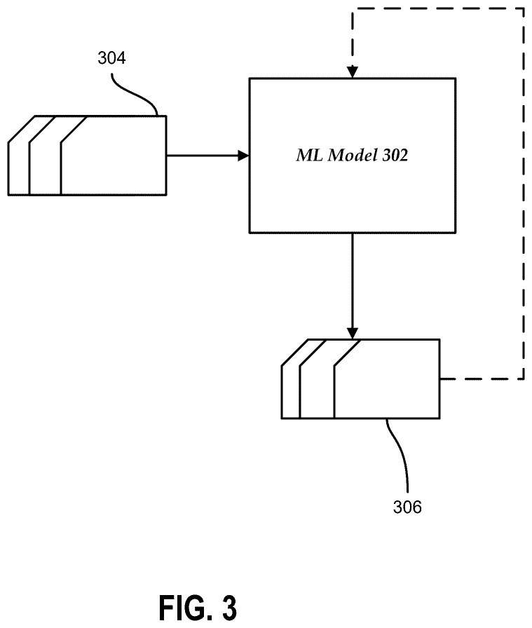

The machine learning model used in connection with this disclosure may take many forms. FIG. 3 illustrates an exemplary machine learning model. Machine learning model 302 may take input 304 (e.g., one or more radio identifiers with bandwidth and/or latency values for those radios together with frame identifiers and frame sizes for frames) and may output 306 groups of frames to be assigned to particular radios. The output parameters may be fed back to the machine learning model as input to train or retrain the machine learning model (e.g., alone or in conjunction with user indications of the accuracy of outputs, labels associated with the inputs, or other reference feedback information). The machine learning model may update its configurations (e.g., weights, biases, or other parameters) based on the assessment of its prediction (e.g., of an information source) and reference feedback information (e.g., user indication of accuracy, reference labels, or other information). Connection weights may be adjusted, for example, if the machine learning model is a neural network, to reconcile differences between the neural network's prediction and the reference feedback. One or more neurons of the neural network may require that their respective errors be sent backward through the neural network to facilitate the update process (e.g., backpropagation of error). Updates to the connection weights may, for example, be reflective of the magnitude of error propagated backward after a forward pass has been completed. In this way, for example, the machine learning model may be trained to generate better predictions of information sources that are responsive to a query.

In some embodiments, the machine learning model may include an artificial neural network. In such embodiments, the machine learning model may include an input layer and one or more hidden layers. Each neural unit of the machine learning model may be connected to one or more other neural units of the machine learning model. Such connections may be enforcing or inhibitory in their effect on the activation state of connected neural units. Each individual neural unit may have a summation function, which combines the values of all of its inputs together. Each connection (or the neural unit itself) may have a threshold function that a signal must surpass before it propagates to other neural units. The machine learning model may be self-learning and/or trained, rather than explicitly programmed, and may perform significantly better in certain areas of problem-solving as compared to computer programs that do not use machine learning. During training, an output layer of the machine learning model may correspond to a classification of the machine learning model, and an input known to correspond to that classification may be input into an input layer of the machine learning model during training. During testing, an input without a known classification may be input into the input layer, and a determined classification may be output.

A machine learning model may include embedding layers in which each feature of a vector is converted into a dense vector representation. These dense vector representations for each feature may be pooled at one or more subsequent layers to convert the set of embedding vectors into a single vector.

The machine learning model may be structured as a factorization machine model. The machine learning model may be a nonlinear model and/or supervised learning model that can perform classification and/or regression. For example, the machine learning model may be a general-purpose supervised learning algorithm that the system uses for both classification and regression tasks. Alternatively, the machine learning model may include a Bayesian model configured to perform variational inference on the graph and/or vector.

Based on splitting the plurality of data frames, bandwidth optimization system 102 may transmit the plurality of portions of the data stream over the plurality of radios. In some embodiments, bandwidth optimization system 102 may instruct each radio to transmit the assigned portions of the data, e.g., via network 150, to a ground station or another type of control center. The multi-radio transmission approach may ensure that the data reaches the recipient, e.g., storage node 104, without significant delays or data loss. As discussed above, bandwidth optimization system 102 may continuously monitor the transmission process and may adjust the allocation of data frames as needed to maintain optimal performance and efficient data transmission. As discussed above, each portion of the data stream may be a frame (e.g., a video frame, a SONAR frame, a LIDAR point cloud/frame, or an infrared frame from an infrared camera).

In some embodiments, as link detection subsystem 116 and data optimization subsystem 118 perform their respective operations, zone detection subsystem 114 may continue to monitor the position of the device hosting bandwidth optimization system 102. Thus, zone detection subsystem 114 may continue detecting whether the device is within the transmit zone or has crossed out of the transmit zone. Based on zone detection subsystem 114 detecting that the recording device 108 has been moved out of the transmit zone, bandwidth optimization system 102 may terminate the transmission of the data stream. For example, upon detecting that a vehicle (e.g., an uncrewed aerial vehicle) exited the transmit zone, zone detection subsystem 114 may trigger one or more operations to end data transmission. In some embodiments, zone detection subsystem 114 may determine that the uncrewed vehicle and/or operator carrying recording device 108 is no longer in the transmit zone. For example, zone detection subsystem 114 may use GPS coordinates, radio frequency identification, geofencing, or other location-based services integrated with the zone detection subsystem 114. Terminating the transmission may ensure that data is only sent when the recording device is within designated transmit zones, complying with the mission plan and reducing the risk of detection in unfriendly areas.

In some embodiments, for example, due to speed of transmission and/or size of the transmit zone, bandwidth optimization system 102 may not be able to transmit all of the data frames before the device hosting bandwidth optimization system 102 leaves the transmit zone. Thus, bandwidth optimization system 102 may take various actions when exiting the transmit zone. For example, bandwidth optimization system 102 may delete the unsent data frames. In particular, bandwidth optimization system 102 may determine that a first portion of the data stream (e.g., video stream) was not transmitted from a vehicle (e.g., an uncrewed aerial vehicle) when the vehicle left the transmit zone. Based on determining that the first portion of the data stream (e.g., video stream) was not transmitted from the vehicle when the vehicle left the transmit zone, bandwidth optimization system 102 may delete the first portion of the video stream. For example, bandwidth optimization system 102 may be transmitting the data in particular portions (e.g., in one-minute portions). When bandwidth optimization system 102 exits the transmit zone, ten minutes of video may not have been transmitting out. Thus, bandwidth optimization system 102 may delete those ten minutes. In some embodiments, bandwidth optimization system 102 may be hosted on a device being carried by an operator. Accordingly, instead of detecting that a vehicle is within a transmit zone or a non-transmit zone, bandwidth optimization system 102 may determine whether the device hosting bandwidth optimization system 102 is within a transmit zone or a non-transmit zone.

In some embodiments, bandwidth optimization system 102 may save any unsent data for future transmission when recording device 108 re-enters another transmit zone, ensuring that critical information is not lost. In particular, bandwidth optimization system 102 may determine that a first portion of the data stream was not transmitted from the recording device when the recording device left the transmit zone. For example, if the recording device is mounted onto a vehicle (e.g., an uncrewed aerial vehicle), bandwidth optimization system 102 may determine that the data stream (e.g., a video stream) was not all transmitted out when the vehicle crossed out of the transmit zone (e.g., into a non-transmit zone).

Based on determining that the first portion of the data stream was not transmitted from the recording device, bandwidth optimization system 102 may determine (e.g., using a machine learning model) whether the first portion of the data stream includes one or more objects identified in the mission plan. For example, bandwidth optimization system 102 may analyze the frames (e.g., using edge analysis or another imaging technique) to determine whether the frames contain images of interest. For example, an uncrewed aerial vehicle may be flying over a forest or a field where no objects of interest (e.g., military objective) are located. Thus, bandwidth optimization system 102 may determine to eventually discard that footage and not have to transmit it. That is, bandwidth optimization system 102 may, based on determining that the first portion of the data stream does not include the one or more objects identified in the mission plan, delete the first portion of the data stream.

In some embodiments, bandwidth optimization system 102 may use a machine learning model to identify objects of interest within the data stream. For example, the machine learning model may be trained using labelled data to identify objects such as tanks, artillery, helicopters, and/or other suitable military objects. The machine learning model may be any model as described above. For example, the machine learning model may be a neural network or another suitable model.

In some embodiments, the objects of interest may be stored as part of a mission plan. One example may include military objects such as tanks, artillery etc. Thus, bandwidth optimization system 102 may retrieve those criteria from the mission plan and perform object detection. Accordingly, bandwidth optimization system 102 may identify objects of interest in the frames. In particular, bandwidth optimization system 102 may, based on determining that the first portion of the data stream includes the one or more objects identified in the mission plan, save the first portion of the data stream for transmission when the recording device reaches another transmission zone. For example, the bandwidth optimization system 102 may detect a tank or an artillery installation within a video stream that was recorded while an uncrewed aerial vehicle was flying within the transmit zone. Accordingly, bandwidth optimization system 102 may save and store that footage for transmission when another transmit zone is reached.

In some embodiments, bandwidth optimization system 102 may perform avoidance detection when transmitting the data (e.g., a video stream). For example, bandwidth optimization system 102 may cause the radios to transmit one at a time at a particular interval (e.g., every thirty seconds). Bandwidth optimization system 102 may retrieve one or more transmission intervals for the plurality of radios. For example, every radio may have the same transmission interval (e.g., thirty seconds). Thus, radio one may have a thirty-second window to transmit, radio two may have a thirty-second interval to transmit, etc. Once all the radios have had a chance to transmit, the order may repeat. It should be noted that in some embodiments, different radios may transmit on different frequencies or different frequency ranges. Accordingly, it would be more difficult to identify the position of the transmitter with different radios transmitting one at a time.

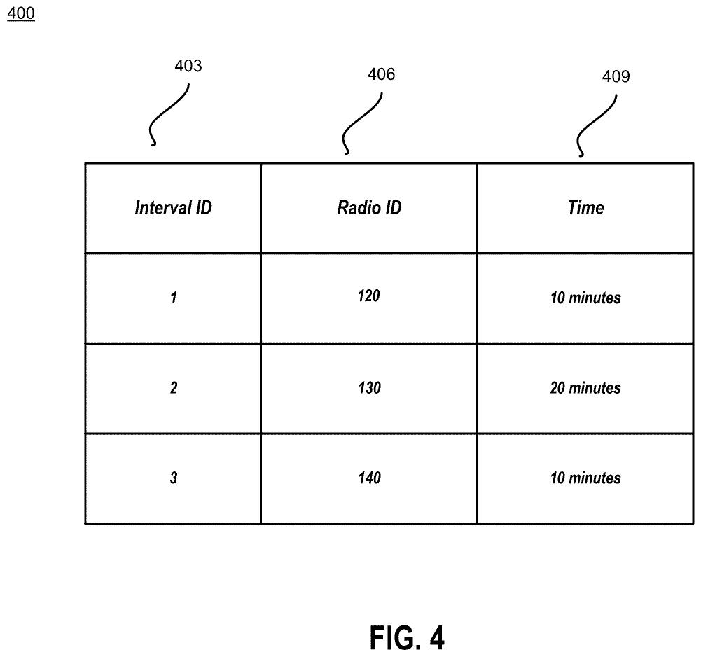

Based on the above, bandwidth optimization system 102 may cause each radio of the plurality of radios to transmit the plurality of portions of the data stream during a corresponding transmission interval of the one or more transmission intervals. Thus, each radio of the plurality of radios may transmit a corresponding portion of the data stream without other radios of the plurality of radios transmitting during that time interval. For example, bandwidth optimization system 102 may transmit a command to each radio for transmitting the data. The command may include a duration. In some embodiments, bandwidth optimization system 102 may just feed the data to the radio for the correct amount of time and, after the time period expires, may ask for the transmission to be terminated. In some embodiments, each radio may have a different transmission interval. For example, some radios may be more prone to detection, and thus, those radios may get a shorter transmission interval. However, some radios may be less prone to detection, and thus, those radios may have a longer transmission interval. FIG. 4 illustrates a data structure 400 for storing different time intervals for different radios. Fields 403 store interval identifiers, while files 406 store radio identifiers, with fields 409 storing time intervals. Thus, each radio may have an assigned time interval. Those time intervals may be different or the same.

In some embodiments, instead of constantly transmitting using different radios, bandwidth optimization system 102 may instruct the radios to transmit simultaneously but during certain intervals (e.g., every thirty seconds). Bandwidth optimization system 102 may retrieve a plurality of transmission intervals for the transmit zone. For example, the transmit intervals may be thirty-second intervals or one-minute intervals that may be used as transmission windows. Any appropriate time intervals may be used. In some embodiments, the time intervals may be different. For example, a thirty-second transmission interval may be followed by a one-minute transmission interval. Bandwidth optimization system 102 may cause the plurality of radios to simultaneously transmit the plurality of portions of the data stream during the plurality of transmission intervals. That is, bandwidth optimization system 102 may pass a command to each radio to transmit for a particular amount of time. In another example, bandwidth optimization system 102 may pass packets or other data to each radio to transmit for a particular amount of time (e.g., thirty seconds, one minute, three minutes, five minutes, etc.). Bandwidth optimization system 102 may then terminate the transmission outside of the plurality of transmission intervals. In some embodiments, the transmission intervals may be stored within a mission plan. In some embodiments, bandwidth optimization system 102 may instruct a vehicle to vary direction of travel during each transmission to make it more difficult to track the vehicle.

In some embodiments, bandwidth optimization system 102 may instruct a vehicle (e.g., an uncrewed aerial vehicle) to vary vehicle velocity for making full transmission possible. In instances when an operator is carrying the device hosting bandwidth optimization system 102, bandwidth optimization system 102 may notify the operator to adjust the velocity of travel (e.g., if the operator is traveling in a vehicle). In particular, bandwidth optimization system 102 may determine, based on velocity of the recording device, that the transmission of the plurality of portions of the data stream over the plurality of radios will not be finished before leaving the transmit zone. For example, bandwidth optimization system 102 may maintain a buffer of data that needs to be sent out. That buffer may be growing during transmission. Accordingly, bandwidth optimization system 102 may determine that all data may not be able to be sent out. Therefore, based on determining that the transmission of the plurality of portions of the data stream will not be finished before leaving the transmit zone, bandwidth optimization system 102 may modify the velocity of the recording device to cause the transmission to be finished before leaving the transmit zone. For example, bandwidth optimization system 102 may instruct the vehicle (e.g., the uncrewed aerial vehicle) to slow down so that the buffer may empty out. In some embodiments, bandwidth optimization system 102 may determine the speed required so that all data is enabled to be sent out. Thus, bandwidth optimization system 102 may determine the transmit rate, the current speed, and the recording rate. Based on that data, bandwidth optimization system 102 may determine the speed that is needed to get all data transmitted out.

### Computing Environment

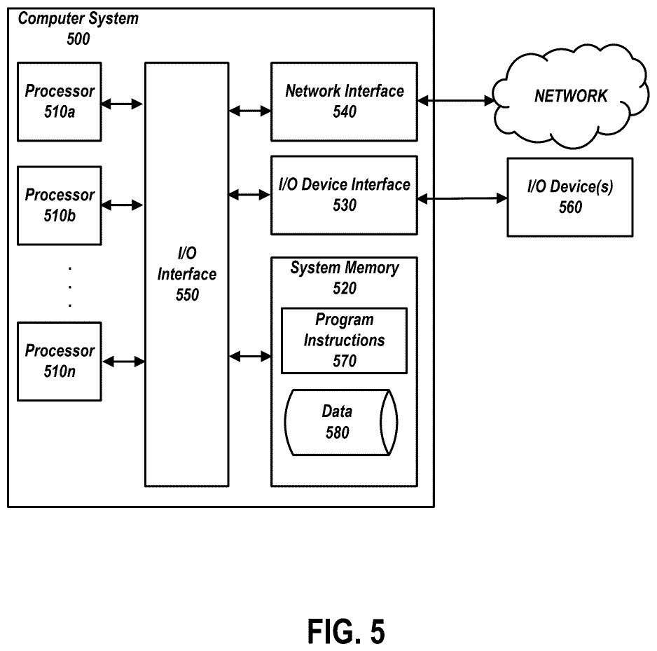

FIG. 5 shows an example computing system that may be used in accordance with some embodiments of this disclosure. In some instances, computing system 500 is referred to as a computer system. The computing system may be hosted on a device (e.g., a smartphone, a tablet, or another suitable device) that an operator may control. In some embodiments, the computing system may be hosted on a server at a datacenter. A person skilled in the art would understand that those terms may be used interchangeably. The components of FIG. 5 may be used to perform some or all operations discussed in relation to FIGS. 1-4. Furthermore, various portions of the systems and methods described herein may include or be executed on one or more computer systems similar to computing system 500. Further, processes and modules described herein may be executed by one or more processing systems similar to that of computing system 500.

Computing system 500 may include one or more processors (e.g., processors 510a-510n) coupled to system memory 520, an input/output (I/O) device interface 530, and a network interface 540 via an I/O interface 550. A processor may include a single processor or a plurality of processors (e.g., distributed processors). A processor may be any suitable processor capable of executing or otherwise performing instructions. A processor may include a central processing unit (CPU) that carries out program instructions to perform the arithmetical, logical, and I/O operations of computing system 500. A processor may execute code (e.g., processor firmware, a protocol stack, a database management system, an operating system, or a combination thereof) that creates an execution environment for program instructions. A processor may include a programmable processor. A processor may include general or special-purpose microprocessors. A processor may receive instructions and data from a memory (e.g., system memory 520). Computing system 500 may be a uni-processor system including one processor (e.g., processor 510a) or a multi-processor system including any number of suitable processors (e.g., 510a-510n). Multiple processors may be employed to provide for parallel or sequential execution of one or more portions of the techniques described herein. Processes, such as logic flows, described herein may be performed by one or more programmable processors executing one or more computer programs to perform functions by operating on input data and generating corresponding output. Processes described herein may be performed by, and apparatus can also be implemented as, special-purpose logic circuitry, e.g., an FPGA (field-programmable gate array) or an ASIC (application-specific integrated circuit). Computing system 500 may include a plurality of computing devices (e.g., distributed computer systems) to implement various processing functions.

I/O device interface 530 may provide an interface for connection of one or more I/O devices 560 to computer system 500. I/O devices may include devices that receive input (e.g., from a user) or output information (e.g., to a user). I/O devices 560 may include, for example, a graphical user interface presented on displays (e.g., a cathode ray tube (CRT) or liquid crystal display (LCD) monitor), pointing devices (e.g., a computer mouse or trackball), keyboards, keypads, touchpads, scanning devices, voice recognition devices, gesture recognition devices, printers, audio speakers, microphones, cameras, or the like. I/O devices 560 may be connected to computer system 500 through a wired or wireless connection. I/O devices 560 may be connected to computer system 500 from a remote location. I/O devices 560 located on remote computer systems, for example, may be connected to computer system 500 via a network and network interface 540.

Network interface 540 may include a network adapter that provides for connection of computer system 500 to a network. Network interface 540 may facilitate data exchange between computer system 500 and other devices connected to the network. Network interface 540 may support wired or wireless communication. The network may include an electronic communication network, such as the Internet, a local area network (LAN), a wide area network (WAN), a cellular communications network, or the like.

System memory 520 may be configured to store program instructions 570 or data 580. Program instructions 570 may be executable by a processor (e.g., one or more of processors 510a-510n) to implement one or more embodiments of the present techniques. Program instructions 570 may include modules of computer program instructions for implementing one or more techniques described herein with regard to various processing modules. Program instructions may include a computer program (which in certain forms is known as a program, software, software application, script, or code). A computer program may be written in a programming language, including compiled or interpreted languages, or declarative or procedural languages. A computer program may include a unit suitable for use in a computing environment, including as a stand-alone program, a module, a component, or a subroutine. A computer program may or may not correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program may be deployed to be executed on one or more computer processors located locally at one site or distributed across multiple remote sites and interconnected by a communication network.

System memory 520 may include a tangible program carrier having program instructions stored thereon. A tangible program carrier may include one or more non-transitory, computer-readable storage media. A non-transitory, computer-readable storage medium may include a machine-readable storage device, a machine-readable storage substrate, a memory device, or any combination thereof. Non-transitory, computer-readable storage medium may include non-volatile memory (e.g., flash memory, ROM, PROM, EPROM, EEPROM), volatile memory (e.g., random access memory (RAM), static random access memory (SRAM), synchronous dynamic RAM (SDRAM)), bulk storage memory (e.g., CD-ROM and/or DVD-ROM, hard drives), or the like. System memory 520 may include a non-transitory, computer-readable storage medium that may have program instructions stored thereon that are executable by a computer processor (e.g., one or more of processors 510a-510n) to cause the subject matter and the functional operations described herein. A memory (e.g., system memory 520) may include a single memory device and/or a plurality of memory devices (e.g., distributed memory devices).

I/O interface 550 may be configured to coordinate I/O traffic between processors 510a-510n, system memory 520, network interface 540, I/O devices 560, and/or other peripheral devices. I/O interface 550 may perform protocol, timing, or other data transformations to convert data signals from one component (e.g., system memory 520) into a format suitable for use by another component (e.g., processors 510a-510n). I/O interface 550 may include support for devices attached through various types of peripheral buses, such as a variant of the Peripheral Component Interconnect (PCI) bus standard or the Universal Serial Bus (USB) standard.

Embodiments of the techniques described herein may be implemented using a single instance of computer system 500 or multiple computer systems 500 configured to host different portions or instances of embodiments. Multiple computer systems 500 may provide for parallel or sequential processing/execution of one or more portions of the techniques described herein.

Those skilled in the art will appreciate that computer system 500 is merely illustrative and is not intended to limit the scope of the techniques described herein. Computer system 500 may include any combination of devices or software that may perform or otherwise provide for the performance of the techniques described herein. For example, computer system 500 may include or be a combination of a cloud-computing system, a data center, a server rack, a server, a virtual server, a desktop computer, a laptop computer, a tablet computer, a server device, a client device, a mobile telephone, a personal digital assistant (PDA), a mobile audio or video player, a game console, a vehicle-mounted computer, a Global Positioning System (GPS), or the like. Computer system 500 may also be connected to other devices that are not illustrated or may operate as a stand-alone system. In addition, the functionality provided by the illustrated components may, in some embodiments, be combined in fewer components or distributed in additional components. Similarly, in some embodiments, the functionality of some of the illustrated components may not be provided, or other additional functionality may be available.

### Operation Flow

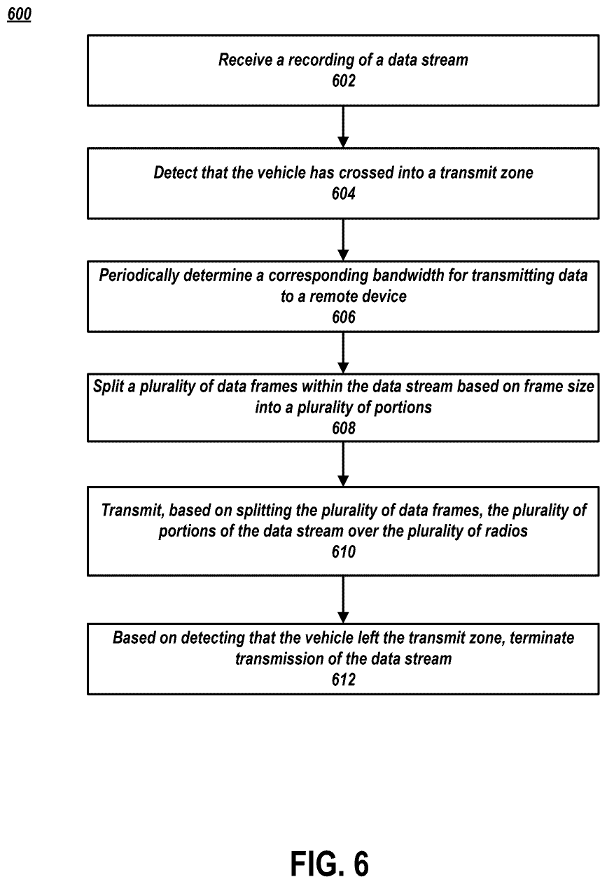

FIG. 6 is a flowchart 600 of operations for optimizing transmission of data. The operations of FIG. 6 may use components described in relation to FIG. 5. In some embodiments, bandwidth optimization system 102 may include one or more components of computing system 500. At 602, bandwidth optimization system 102 receives a recording of a data stream. For example, bandwidth optimization system 102 may receive a video stream from recording device 108 (e.g., a video camera mounted onto an uncrewed aerial vehicle). Bandwidth optimization system 102 may receive the video stream using I/O device interface 530. In some embodiments, bandwidth optimization system 102 may receive the data stream using network interface 540.

At 604, bandwidth optimization system 102 detects that the vehicle has crossed into a transmit zone. For example, bandwidth optimization system 102 may use one or more processors 510a, 510b, and/or 510n to perform the detection. At 606, bandwidth optimization system 102 periodically determines a corresponding bandwidth (and/or latency) for transmitting data to a remote device. For example, bandwidth optimization system 102 may use one or more processors 510a-510n to perform the determination. In some embodiments, bandwidth optimization system 102 may use I/O device interface 530 to request coordinates (e.g., from a Global Positioning System device) to perform the determination.

At 608, bandwidth optimization system 102 splits a plurality of data frames within the data stream based on frame size into a plurality of portions. Bandwidth optimization system 102 may perform this operation using one or more processors 510a, 510b, and/or 510n. At 610, bandwidth optimization system 102 transmits, based on splitting the plurality of data frames, the plurality of portions of the data stream over the plurality of radios. Bandwidth optimization system 102 may use one or more processors 510a, 510b, and/or 510n to instruct the radios to transmit the data frames. The data frames may be stored in system memory 520 separated into different buckets for different radios. At 612, bandwidth optimization system 102, based on detecting that the vehicle left the transmit zone, terminates transmission of the data stream. Bandwidth optimization system 102 may perform this operation using one or more processors 510a, 510b, and/or 510n. In some embodiments, instead of performing the detection based on a vehicle location, bandwidth optimization system 102 may use location of an operator carrying a device hosting bandwidth optimization system 102.

Although the present invention has been described in detail for the purpose of illustration based on what is currently considered to be the most practical and preferred embodiments, it is to be understood that such detail is solely for that purpose and that the invention is not limited to the disclosed embodiments but, on the contrary, is intended to cover modifications and equivalent arrangements that are within the scope of the appended claims. For example, it is to be understood that the present invention contemplates that, to the extent possible, one or more features of any embodiment can be combined with one or more features of any other embodiment.

The above-described embodiments of the present disclosure are presented for purposes of illustration, and not of limitation, and the present disclosure is limited only by the claims that follow. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

The present techniques will be better understood with reference to the following enumerated embodiments:
1. A method comprising: recording, using a recording device, a data stream as a vehicle moves according to a mission plan; detecting, at the vehicle, that the vehicle has crossed into a transmit zone, wherein the transmit zone is a predetermined zone indicated for data transmission in the mission plan; based on detecting that the vehicle has crossed into the transmit zone, periodically determining, for each radio of a plurality of radios on board the vehicle as the vehicle moves through the transmit zone, a corresponding bandwidth for transmitting data to a remote device; splitting a plurality of data frames within the data stream based on frame size into a plurality of portions to be transmitted by each radio of the plurality of radios, wherein each data frame of the plurality of data frames is matched to a radio of the plurality of radios based on a corresponding frame size; transmitting, based on splitting the plurality of data frames, the plurality of portions of the data stream over the plurality of radios; and based on detecting that the vehicle left the transmit zone, terminating transmission of the data stream.
2. Any of the preceding embodiments, further comprising: determining that a first portion of the data stream was not transmitted from the vehicle when the vehicle left the transmit zone; based on determining that the first portion of the data stream was not transmitted from the vehicle, determining, using a machine learning model, whether the first portion of the data stream includes one or more objects identified in the mission plan; based on determining that the first portion of the data stream includes the one or more objects identified in the mission plan, saving the first portion of the data stream for transmission when the vehicle reaches a different transmit zone; and based on determining that the first portion of the data stream does not include the one or more objects identified in the mission plan, deleting the first portion of the data stream.
3. Any of the preceding embodiments, further comprising: determining that a first portion of the data stream was not transmitted from the vehicle when the vehicle left the transmit zone; and based on determining that the first portion of the data stream was not transmitted from the vehicle when the vehicle left the transmit zone, deleting the first portion of the data stream.
4. Any of the preceding embodiments, further comprising: retrieving one or more transmission intervals for the plurality of radios; and causing each radio of the plurality of radios to transmit the plurality of portions of the data stream during a corresponding transmission interval of the one or more transmission intervals, wherein each radio of the plurality of radios transmits a corresponding portion of the data stream without other radios of the plurality of radios transmitting during that time interval.
5. Any of the preceding embodiments, further comprising: retrieving a plurality of transmission intervals for the transmit zone; causing the plurality of radios to simultaneously transmit the plurality of portions of the data stream during the plurality of transmission intervals; and terminating the transmission outside of the plurality of transmission intervals.
6. Any of the proceeding embodiments, further comprising: determining, based on velocity of the vehicle, that the transmission of the plurality of portions of the data stream over the plurality of radios will not be finished before leaving the transmit zone; and based on determining that the transmission of the plurality of portions of the data stream will not be finished before leaving the transmit zone, modifying the velocity of the vehicle to cause the transmission to be finished before leaving the transmit zone.
7. Any of the preceding embodiments, wherein determining, for each radio of the plurality of radios, the corresponding bandwidth further comprises: periodically determining a velocity associated with the vehicle; based on the velocity, determining a time interval for determining the corresponding bandwidth; and determining one or more of a signal-to-noise ratio or an error rate according to the time interval.
8. A tangible, non-transitory, machine-readable medium storing instructions that, when executed by a data processing apparatus, cause the data processing apparatus to perform operations comprising those of any of embodiments 1-7.
9. A system comprising: one or more processors; and memory storing instructions that, when executed by the processors, cause the processors to effectuate operations comprising those of any of embodiments 1-7.
10. A system comprising means for performing any of embodiments 1-7.

What is claimed is:

1. A system for optimizing transmission of data, the system comprising:
one or more processors; and
memory for storing instructions, which, when executed by the one or more processors, cause the one or more processors to perform operations comprising:
recording, using a camera, a video stream as an uncrewed aerial vehicle moves according to a mission plan;
detecting, at the uncrewed aerial vehicle, that the uncrewed aerial vehicle has crossed into a transmit zone, wherein the transmit zone is a predetermined zone indicated for data transmission in the mission plan;
based on detecting that the uncrewed aerial vehicle has crossed into the transmit zone, periodically determining, for each radio of a plurality of radios on board the uncrewed aerial vehicle as the uncrewed aerial vehicle moves through the transmit zone, a corresponding bandwidth value and a corresponding latency value for transmitting data to a remote device;
splitting a plurality of frames within the video stream based on frame size into a plurality of portions to be transmitted by each radio of the plurality of radios, wherein each frame of the plurality of frames is matched to a radio of the plurality of radios based on a corresponding frame size;
transmitting, based on splitting the plurality of frames, the plurality of portions of the video stream over the plurality of radios; and
based on detecting that the uncrewed aerial vehicle left the transmit zone, terminating the data transmission of the video stream.

2. The system of claim 1, wherein the instructions further cause the one or more processors to perform operations comprising:
determining that a first portion of the video stream was not transmitted from the uncrewed aerial vehicle when the uncrewed aerial vehicle left the transmit zone;
based on determining that the first portion of the video stream was not transmitted from the uncrewed aerial vehicle, determining, using a machine learning model, whether the first portion of the video stream includes one or more objects identified in the mission plan;
based on determining that the first portion of the video stream includes the one or more objects identified in the mission plan, saving the first portion of the video stream for transmitting when the uncrewed aerial vehicle reaches a different transmit zone; and
based on determining that the first portion of the video stream does not include the one or more objects identified in the mission plan, deleting the first portion of the video stream.

3. The system of claim 1, wherein the instructions further cause the one or more processors to perform operations comprising:
determining that a first portion of the video stream was not transmitted from the uncrewed aerial vehicle when the uncrewed aerial vehicle left the transmit zone; and
based on determining that the first portion of the video stream was not transmitted from the uncrewed aerial vehicle when the uncrewed aerial vehicle left the transmit zone, deleting the first portion of the video stream.

4. The system of claim 1, wherein the instructions for transmitting the plurality of portions of the video stream over the plurality of radios further cause the one or more processors to perform operations comprising:
retrieving one or more transmission intervals for the plurality of radios; and
causing each radio of the plurality of radios to transmit the plurality of portions of the video stream during a corresponding transmission interval of the one or more transmission intervals, wherein each radio of the plurality of radios transmits a corresponding portion of the video stream without other radios of the plurality of radios transmitting during that time interval.

5. The system of claim 1, wherein the instructions for transmitting the plurality of portions of the video stream over the plurality of radios comprises:
retrieving a plurality of transmission intervals for the transmit zone;
causing the plurality of radios to simultaneously transmit the plurality of portions of the video stream during the plurality of transmission intervals; and
terminating the transmission outside of the plurality of transmission intervals.

6. The system of claim 1, wherein the instructions further cause the one or more processors to perform operations comprising:
determining, based on velocity of the uncrewed aerial vehicle, that the transmission of the plurality of portions of the video stream over the plurality of radios will not be finished before leaving the transmit zone; and
based on determining that the transmission of the plurality of portions of the video stream will not be finished before leaving the transmit zone, modifying the velocity of the uncrewed aerial vehicle to cause the transmission to be finished before leaving the transmit zone.

7. The system of claim 1, wherein the instructions for periodically determining, for each radio of the plurality of radios, the corresponding bandwidth value and the corresponding latency value as the uncrewed aerial vehicle moves through the transmit zone further cause the one or more processors to perform operations comprising:
periodically determining a velocity associated with the uncrewed aerial vehicle;
based on the velocity, determining a time interval for determining the corresponding bandwidth value and the corresponding latency value; and
determining one or more of a signal-to-noise ratio or an error rate according to the time interval.

8. A method comprising:
recording, using a recording device, a data stream as a vehicle moves according to a mission plan;
detecting, at the vehicle, that the vehicle has crossed into a transmit zone, wherein the transmit zone is a predetermined zone indicated for data transmission in the mission plan;
based on detecting that the vehicle has crossed into the transmit zone, periodically determining, for each radio of a plurality of radios on board the vehicle as the vehicle moves through the transmit zone, a corresponding bandwidth for transmitting data to a remote device;
splitting a plurality of data frames within the data stream based on frame size into a plurality of portions to be transmitted by each radio of the plurality of radios, wherein each data frame of the plurality of data frames is matched to a radio of the plurality of radios based on a corresponding frame size;
transmitting, based on splitting the plurality of data frames, the plurality of portions of the data stream over the plurality of radios; and
based on detecting that the vehicle left the transmit zone, terminating transmission of the data stream.

9. The method of claim 8, further comprising:
determining that a first portion of the data stream was not transmitted from the vehicle when the vehicle left the transmit zone;
based on determining that the first portion of the data stream was not transmitted from the vehicle, determining, using a machine learning model, whether the first portion of the data stream includes one or more objects identified in the mission plan;
based on determining that the first portion of the data stream includes the one or more objects identified in the mission plan, saving the first portion of the data stream for transmission when the vehicle reaches a different transmit zone; and
based on determining that the first portion of the data stream does not include the one or more objects identified in the mission plan, deleting the first portion of the data stream.

10. The method of claim 8, further comprising:
determining that a first portion of the data stream was not transmitted from the vehicle when the vehicle left the transmit zone; and
based on determining that the first portion of the data stream was not transmitted from the vehicle when the vehicle left the transmit zone, deleting the first portion of the data stream.

11. The method of claim 8, further comprising:
retrieving one or more transmission intervals for the plurality of radios; and
causing each radio of the plurality of radios to transmit the plurality of portions of the data stream during a corresponding transmission interval of the one or more transmission intervals, wherein each radio of the plurality of radios transmits a corresponding portion of the data stream without other radios of the plurality of radios transmitting during that time interval.

12. The method of claim 8, further comprising:
retrieving a plurality of transmission intervals for the transmit zone;
causing the plurality of radios to simultaneously transmit the plurality of portions of the data stream during the plurality of transmission intervals; and
terminating the transmission outside of the plurality of transmission intervals.

13. The method of claim 8, further comprising:
determining, based on velocity of the vehicle, that the transmission of the plurality of portions of the data stream over the plurality of radios will not be finished before leaving the transmit zone; and
based on determining that the transmission of the plurality of portions of the data stream will not be finished before leaving the transmit zone, modifying the velocity of the vehicle to cause the transmission to be finished before leaving the transmit zone.

14. The method of claim 8, wherein determining, for each radio of the plurality of radios, the corresponding bandwidth further comprises:
periodically determining a velocity associated with the vehicle;
based on the velocity, determining a time interval for determining the corresponding bandwidth; and
determining one or more of a signal-to-noise ratio or an error rate according to the time interval.

15. One or more non-transitory, computer-readable media storing instructions thereon, wherein the instructions cause one or more processors to perform operations comprising:
receiving, from a recording device, a recording of a data stream as the recording device is moved according to a mission plan;
detecting that the recording device has been moved into a transmit zone, wherein the transmit zone is a predetermined zone indicated for data transmission in the mission plan;
based on detecting that the recording device has been moved into the transmit zone, periodically determining, for each radio of a plurality of radios, linked with the recording device as the recording device is moved through the transmit zone, a corresponding bandwidth value and a corresponding latency value for transmitting data to a remote device;
splitting, based on frame size, a plurality of data frames within the data stream into a plurality of portions to be transmitted by each radio of the plurality of radios, wherein each data frame of the plurality of data frames is matched to a radio of the plurality of radios based on a corresponding frame size;
transmitting, based on splitting the plurality of data frames, the plurality of portions of the data stream over the plurality of radios; and
based on detecting that the recording device has been moved out of the transmit zone, terminating transmission of the data stream.

16. The one or more non-transitory, computer-readable media of claim 15, wherein the instructions further cause the one or more processors to perform operations comprising:
determining that a first portion of the data stream was not transmitted from the recording device when the recording device left the transmit zone;
based on determining that the first portion of the data stream was not transmitted from the recording device, determining, using a machine learning model, whether the first portion of the data stream includes one or more objects identified in the mission plan;
based on determining that the first portion of the data stream includes the one or more objects identified in the mission plan, saving the first portion of the data stream for transmission when the recording device reaches another transmission zone; and
based on determining that the first portion of the data stream does not include the one or more objects identified in the mission plan, deleting the first portion of the data stream.

17. The one or more non-transitory, computer-readable media of claim 15, wherein the instructions further cause the one or more processors to perform operations comprising:
determining that a first portion of the data stream was not transmitted from the recording device when the recording device left the transmit zone; and
based on determining that the first portion of the data stream was not transmitted from the recording device when the recording device left the transmit zone, deleting the first portion of the data stream.

18. The one or more non-transitory, computer-readable media of claim 15, wherein the instructions further cause the one or more processors to perform operations comprising:
retrieving one or more transmission intervals for the plurality of radios; and
causing each radio of the plurality of radios to transmit the plurality of portions of the data stream during a corresponding transmission interval of the one or more transmission intervals, wherein each radio of the plurality of radios transmits a corresponding portion of the data stream without other radios of the plurality of radios transmitting during that time interval.

19. The one or more non-transitory, computer-readable media of claim 15, wherein the instructions further cause the one or more processors to perform operations comprising:
retrieving a plurality of transmission intervals for the transmit zone;
causing the plurality of radios to simultaneously transmit the plurality of portions of the data stream during the plurality of transmission intervals; and
terminating the transmission outside of the plurality of transmission intervals.

20. The one or more non-transitory, computer-readable media of claim 15, wherein the instructions further cause the one or more processors to perform operations comprising:
determining, based on velocity of the recording device, that the transmission of the plurality of portions of the data stream over the plurality of radios will not be finished before leaving the transmit zone; and
based on determining that the transmission of the plurality of portions of the data stream will not be finished before leaving the transmit zone, modifying the velocity of the recording device to cause the transmission to be finished before leaving the transmit zone.
